(19) United States
(12) Patent Application Publication
(10) Pub. No.: US 2020/0359813 A1
(43) Pub. Date: Nov. 19, 2020

(54) Electric Blanket Enclosure

(71) Applicants: Miranda Adele Lafleur, McGregor (CA); Elizabeth Coles-Ouellette, Amherstburg (CA)

(72) Inventors: Miranda Adele Lafleur, McGregor (CA); Elizabeth Coles-Ouellette, Amherstburg (CA)

(21) Appl. No.: 16/413,995

(22) Filed: May 16, 2019

(51) Int. Cl. A47G 9/02

(52) U.S. Cl. CPC A47G 9/0261; H05B 3/342; A47G 9/0223; A47G 9/0215

(57) ABSTRACT

An electric blanket enclosure that is configured to mateably receive an electric blanket within the interior volume thereof so as to inhibit soiling of the electric blanket. The electric blanket enclosure includes a body having opposing walls forming a void therebetween. The opposing walls are secured along the peripheral edges thereof and further include a first layer and a second layer. The body of the present invention includes a first end and a second end wherein first end further includes an opening. The opening proximate the first end extends across the width of the body. A storage compartment is formed on an inner surface of one of the opposing walls. A second opening is formed in the body and the second opening is configured to have an electrical cord journaled therethrough. The second layer of the opposing walls are manufactured from a fire retardant material.

### FIELD OF THE INVENTION

The present invention relates generally to bedding accessories, more specifically but not by way of limitation an electric blanket cover that is configured to have an electric blanket disposed therein wherein the present invention is operable to maintain cleanliness of the electric blanket and further provide protection for the user thereof.

### BACKGROUND

Electric blankets are well known in the art. Conventional electric blankets are configured with heating elements disposed therein wherein the heating elements are electrically coupled to a conventional power source utilizing a plug. A thermostat controller is typically present that is operable to provide adjustment of the current through the heating elements and as such the temperature. Electric blankets are commonly used in areas where extreme cold can be present and as such maintaining the temperature of the house at a temperature that is comfortable can be expensive. Utilizing an electric blanket can be a cost effective manner to provide comfort to an individual during times when heating a room is not possible or cost effective.

One issue with electric blankets is the ability to maintain the cleanliness of the blanket during use. As electric blankets cannot be laundered they can routinely become soiled during use. This is undesirable for a user and there is no effective technique for cleaning an electric blanket. Electric blankets are further at risk for being a fire hazard. As the electric blankets age, the heating elements and wiring become compromised and as such the wires and heating elements are known to initiate ignition of flames with the blanket potentially causing harm to a user thereof.

Accordingly, there is a need for an electric blanket enclosure that is configured to have an electric blanket disposed therein wherein the enclosure is further operable to suppress a fire if the electric blanket disposed therein has a malfunction.

### SUMMARY OF THE INVENTION

It is the object of the present invention to provide an electric blanket enclosure configured to maintain the cleanliness of the electric blanket wherein the electric blanket enclosure includes a body formed in a pouch style design.

Another object of the present invention is to provide an electric blanket enclosure operable to receive an electric blanket within the interior volume thereof wherein the body includes a first end and a second end.

A further object of the present invention is to provide an electric blanket enclosure configured to maintain the cleanliness of the electric blanket wherein the first end of the electric blanket enclosure includes an opening formed therein.

Still another object of the present invention is to provide an electric blanket enclosure operable to receive an electric blanket within the interior volume thereof wherein the opening includes a securing device operable to close the opening ensuing deposit of the electric blanket therein.

An additional object of the present invention is to provide an electric blanket enclosure configured to maintain the cleanliness of the electric blanket wherein the securing device in a preferred embodiment is a zipper.

Yet a further object of the present invention is to provide an electric blanket enclosure operable to receive an electric blanket within the interior volume thereof wherein the interior volume of the body includes a storage pocket on the inner surface of the wall that is configured to store the electrical cord of the electric blanket when not in use.

Another object of the present invention is to a provide an electric blanket enclosure configured to maintain the cleanliness of the electric blanket wherein the first end includes a second opening wherein the second opening is configured to have the electrical cord journaled therethrough.

An alternate object of the present invention is to provide an electric blanket enclosure operable to receive an electric blanket within the interior volume thereof wherein the body includes a wall having alternate layers wherein one of the layers is manufactured from a fire retardant material.

An additional object of the present invention is to provide an electric blanket enclosure configured to maintain the cleanliness of the electric blanket wherein the body wall further includes a layer that is configured to inhibit passage of radiation.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is front view of a preferred embodiment of the present invention; and

FIG. 2 is cross sectional of the body of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an electric blanket enclosure 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

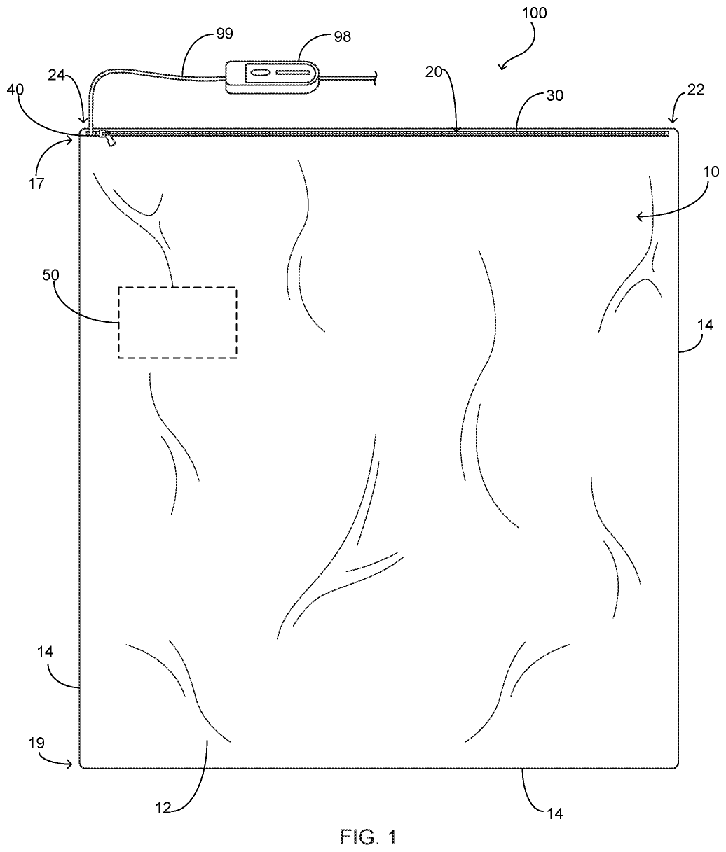

Now referring in particular to the Figures submitted herewith, the electric blanket enclosure 100 includes a body 10 that is manufactured having opposing walls 12 sewn together along the peripheral edges 14 of the walls 12. The view in FIG. 1 is a front view of the present invention and as such the wall opposing the wall 12 illustrated is not particularly shown therein. It should be understood by those skilled in the art that the body 10 includes two walls 12 having a void therebetween wherein the void 5 is configured to receive a conventional electric blanket therein. The walls 12 are secured along three perimeter edges 14 utilizing suitable durable techniques such as but not limited to sewing. It is contemplated within the scope of the present invention that the body 10 could be formed in alternate sizes so as to be mateably sized with a desired electric blanket. The body 10 includes a first end 17 and a second end 19. Second end 19 is sealed closed as previously described herein utilizing sewing or other suitable technique. The first end 17 is formed having an opening 20 wherein the opening 20 extends substantially intermediate the first side 22 and second side 24 of the body 10.

The opening 20 provides access to the void 5 that is intermediate the opposing walls 12 of the body 10. The opening 20 extends substantially across the width of the body 10 in order to facilitate the accommodation of a mateably sized electric blanket. The opening 20 is transitioned intermediate an open state and a closed state utilizing securing device 30. Securing device 30 is attached to the opening 20 utilizing suitable durable techniques. In the preferred embodiment the securing device 30 is a zipper. While a zipper is illustrated herein as being the securing device 30, it is contemplated within the scope of the present invention that the securing device 30 could be formed from alternate elements such as but not limited to hook and loop fastener.

The body 10 further includes a second opening 40. Second opening 40 is configured to have electrical cord 99 journaled therethrough subsequent disposal of an electric blanket within void 5. The second opening 40 is manufactured in size to accommodate the electrical cord 99 and its controller 98. In the preferred embodiment the second opening 40 does not require or have a closure device. It is additionally further contemplated within the scope of the present invention that the second opening 40 could be formed in alternate locations of the body 10. While the second opening 40 is illustrated herein proximate the first end 17 of the body 10, it is within the scope of the present invention that the second opening 40 could be placed in any location on the body 10 so as to be adjacent the position of the electrical cord 99 allowing journaling therethrough.

Formed on the interior surface of a wall 12 is storage compartment 50. Storage compartment 50 is operable to receive and store electrical cord 99 when the electric blanket enclosure 100 is not in use. It should be understood within the scope of the present invention that the storage compartment 50 could be manufactured in alternate sizes. Furthermore, it is contemplated within the scope of the present invention that the storage compartment 50 could be formed utilizing a suitable material such as but not limited to cloth wherein the material is secured to the inner surface of the wall 12 by stitching or other suitable technique. While the storage compartment 50 is illustrated herein as being in a particular location, it is contemplated within the scope of the present invention that the storage compartment 50 could be placed in alternate locations.

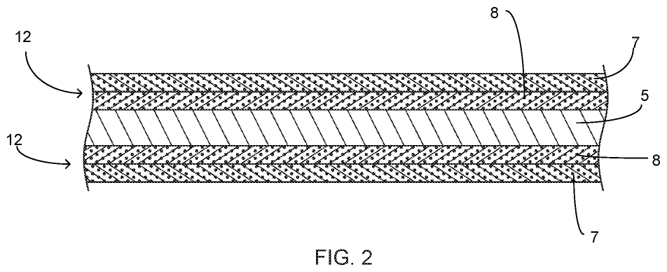

Now referring in particular to FIG. 2, a cross sectional of the body 10 is illustrated therein. The walls 12 of the body 10 include a first layer 7 and a second layer 8. The first layer 7 and second layer 8 are formed together utilizing suitable durable techniques. The first layer 7 is the outermost layer of the wall 12 which a user of the electric blanket enclosure 100 will contact during use thereof. As the user will be engaged with the first layer 7 during utilization of the electric blanket enclosure 100, it is desired within the scope of the present invention that the first layer 7 is manufactured from a comfortable soft material such as but not limited to cotton. It should be recognized by those skilled in the art that the first layer 7 could be manufactured from numerous alternate materials in order to achieve the desired functionality described herein.

The second layer 8 is intermediate the first layer 7 and void 5. The second layer 8 is operable to inhibit the spread of fire and or flames in the event that an electric blanket disposed within the void 5 ignites. As is known in the art, conventional electric blankets do present certain risks the most serious of which is a fire hazard most commonly caused by compromised electrical wiring. Utilization of the electric blanket enclosure 100 provides an additional safety element wherein the second layer 8 will provide fire retardation in the event that an electric blanket disposed within the void 5 ignites. In a preferred embodiment of the present invention it is contemplated that the second layer 8 is manufactured from Nomex or modacrylic. While the two aforementioned materials are preferred, it is contemplated within the scope of the present invention that alternate suitable materials could be utilized for the second layer 8 of the wall 12.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. An electric blanket enclosure comprising:
a body, said body having opposing walls forming a void therebetween, said body having a first end and a second end, said body having a first side and a second side, said opposing walls having peripheral edges wherein said peripheral edges of said opposing walls are operably secured, said body being of suitable size to receive an electric blanket within the void thereof;
a first opening, said first opening being proximate said first end of said body, said first opening configured to have an open position and a closed position, said first opening extending substantially intermediate said first side and said second side; and
wherein said opposing walls further include a first layer and a second layer.

2. The electric blanket enclosure as recited in claim 1, wherein said first opening further includes a securing device, said securing device configured to transition said first opening intermediate said open position and said closed position.

3. The electric blanket enclosure as recited in claim 2, wherein said securing device is a zipper.

4. The electric blanket enclosure as recited in claim 3, wherein said second layer of said opposing walls is manufactured from a fire retardant material.

5. The electric blanket enclosure as recited in claim 4, and further including a storage compartment, said storage compartment formed on an inner surface of one of said opposing walls, said storage compartment operable to receive and retain a portion of an electrical cord of an electric blanket.

6. The electric blanket enclosure as recited in claim 5, and further including a second opening, said second opening formed in one of said opposing walls of said body, said second opening configured to have an electrical cord journaled therethrough.

7. The electric blanket enclosure as recited in claim 6, wherein said first layer of said opposing walls is manufactured from cotton.

8. An electric blanket enclosure that is configured to receive an electric blanket therein wherein the electric blanket enclosure inhibits soiling of the electric blanket and is further configured to provide fire suppression wherein the electric blanket enclosure comprises:
a body, said body having opposing walls forming a void therebetween, said opposing walls having a first layer and a second layer, said first layer and said second layer being adjacent, said body having a first end and a second end, said body having a first side and a second side, said opposing walls having peripheral edges wherein said peripheral edges of said opposing walls are operably secured, said body being sized to mateably receive an electric blanket within the void thereof;
a first opening, said first opening being proximate said first end of said body, said first opening configured to have an open position and a closed position, said first opening extending substantially intermediate said first side and said second side;
a second opening, said second opening being formed in one of said opposing wall, said second opening being formed of a suitable size so as to accommodate an electrical cord being journaled therethrough.

9. The electric blanket enclosure as recited in claim 8, and further including a securing device, said securing device being operably coupled to said first opening, said securing device configured to provide opening and closing of said first opening, said securing device being a zipper.

10. The electric blanket enclosure as recited in claim 9, and further including a storage compartment, said storage compartment being formed on an inner surface of one of said opposing walls, said storage compartment configured to receive and retain an electrical cord of an electric blanket when not in use.

11. The electric blanket enclosure as recited in claim 10, wherein said second layer of said opposing walls is manufactured from a fire retardant material.

12. The electric blanket enclosure as recited in claim 11, wherein said first layer of said opposing walls is manufactured from cotton.

13. The electric blanket enclosure as recited in claim 12, wherein said second opening can be formed in alternate locations on said body.
